(19) United States
(12) Patent Application Publication
(10) Pub. No.: US 2008/0319608 A1
(43) Pub. Date: Dec. 25, 2008

(54) Anti-Rolling Method and System for a Vehicle and Corresponding Vehicle

(75) Inventor: Richard Pothin, Jouars-Pontchartrain (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT s.a.s, Boulogne Billancourt (FR)

(21) Appl. No.: 11/994,561

(22) PCT Filed: Jul. 4, 2006
(86) PCT No.: PCT/FR2006/050672

§ 371 Date: Jul. 10, 2008

(30) Foreign Application Priority Data
Jul. 5, 2005 (FR) 0507113

(51) Int. Cl. B60G 21/00

(52) U.S. Cl. 701/38

(57) ABSTRACT

The invention concerns a method for controlling an anti-rolling system for a vehicle having at least three wheels, whereby based on the turn angle of the front wheel or on the lateral acceleration of the vehicle, on displacement data of the vehicle, and on a prior deflection rule of the anti-rolling system, a current roll correction rule is provided and said current roll correction rule is sent to an anti-rolling actuator or a controllable suspension acting on the stiffness of the vehicle suspension.

The present invention relates to the field of control systems for land vehicles, in particular for wheeled automobile vehicles.

Automobile vehicles are traditionally provided with a chassis, a passenger compartment, and wheels attached to the chassis by a suspension mechanism, with steerable front wheels controlled by a steering wheel available to the driver in the passenger compartment of the vehicle, and steerable or non-steerable rear wheels.

US document 2004/0117085 describes a yaw stability control system for a vehicle, equipped with a lateral acceleration sensor, a roll sensor, a steering-angle sensor and at least one speed sensor supplying information to a yaw stability control unit, a roll stability control unit and a priority and integration function unit making it possible to control an active suspension system and an active roll-bar system.

US document 4939654 describes a system for controlling the driving characteristics of a vehicle as a function of the steering angle of the vehicle wheels by means of a steering-angle sensor and at least one speed sensor for acting on adjustable shock absorbers.

However, these systems necessitate numerous sensors and do not achieve sufficiently stable behavior of the vehicle during certain maneuvers of the driver or under certain road conditions. Some situations may cause a loss of control of the vehicle, for example while avoiding a single or double obstacle. The losses of control in such a case are often due to inappropriate vehicle response, because it is too sudden, not sufficiently damped or else not very predictable.

The object of the invention is an anti-rollover control system that ensures safety, a feeling of safety, comfort and increased driving pleasure.

The method for control of an anti-rollover system for a vehicle having at least three wheels provides that, as a function of the steering angle of the front wheels or of the lateral acceleration of the vehicle, of displacement data of the vehicle and of a prior steering-angle setpoint of the anti-rollover system, a current setpoint is formulated for roll correction and the said current roll-correction setpoint is sent to an anti-rollover actuator or to an adjustable suspension acting on the stiffness of a vehicle suspension. In this way the roll affecting a vehicle may be effectively countered.

In one embodiment, the displacement data of the vehicle comprise the longitudinal speed of the vehicle. The longitudinal speed may be measured by at least one sensor forming part of an anti wheel-lock system.

In one embodiment, the displacement data of the vehicle comprise a measurement of the steering angle of the rear wheels, in the case of a vehicle having steerable rear wheels.

Advantageously, the dynamic response of the vehicle and the static response of the vehicle are regulated separately. Regulation may be achieved in simple manner.

Advantageously a current roll-correction setpoint is formulated from a model of the vehicle and displacement data of the vehicle. The current roll-correction setpoint may be formulated in an open loop. In other words, the presence of a roll sensor is not indispensable. The roll-correction setpoint may be formulated as a function of the dynamics of the said anti-rollover actuator or adjustable suspension.

The anti-rollover system for a vehicle having at least three wheels comprises a means for formulating a current roll-correction setpoint as a function of the steering angle of the front wheels or of the vehicle acceleration, of displacement data of the vehicle and of a prior roll-correction setpoint, and an anti-rollover actuator or an adjustable suspension capable of acting on the stiffness of a vehicle suspension upon reception of the said current roll-correction setpoint.

In one embodiment, the means for formulating a setpoint comprises a modeling module capable of furnishing an estimate of at least one variable.

In one embodiment, the modeling module comprises an input for the steering angle of the front wheels or for the lateral acceleration of the vehicle, an input for the speed of displacement of the vehicle and an input for the prior setpoint of the steering angle of the rear wheels.

In one embodiment, the modeling module comprises an output for roll angle, an output for roll rate and a filtered torque output.

The means for formulating a setpoint may comprise a module for regulating the transient part and a module for regulating the static part.

The module for regulating the transient part may comprise outputs connected to the inputs of the module for regulating static parts. The module for regulating static parts may additionally comprise an input for steering angle of the front wheels or for lateral acceleration of the vehicle and an input for speed of displacement of the vehicle.

The vehicle provided with a chassis and at least three wheels attached elastically to the chassis comprises an anti-rollover system comprising a means for formulating a current roll-correction setpoint as a function of the steering angle of the front wheels or of the lateral acceleration of the vehicle, of displacement data of the vehicle and of a prior roll-correction setpoint, and an anti-rollover actuator or an adjustable suspension capable of acting on the stiffness of a vehicle suspension upon reception of the said current roll-correction setpoint.

By using the steering angle of the front wheels, the control method is particularly fast. By using the lateral acceleration of the vehicle, the control method permits excellent vehicle behavior, especially on roads providing poor grip.

The present invention will be better understood by reading the detailed description of some embodiments, given by way of examples that are in no way limitative and are illustrated by the attached drawings, wherein:

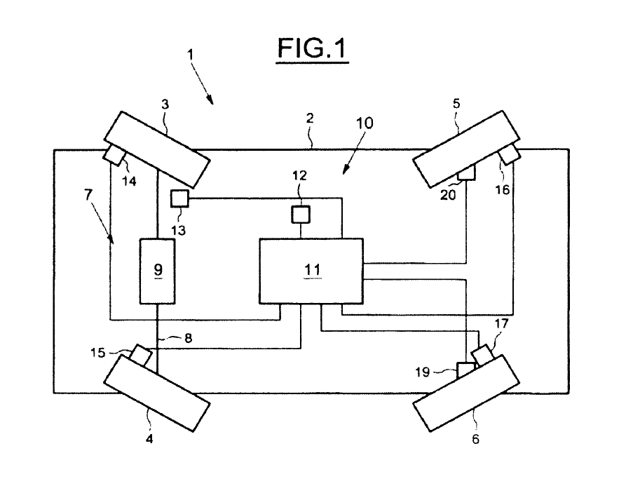

FIG. 1 is a schematic view of a vehicle equipped with a control system according to one aspect of the invention;

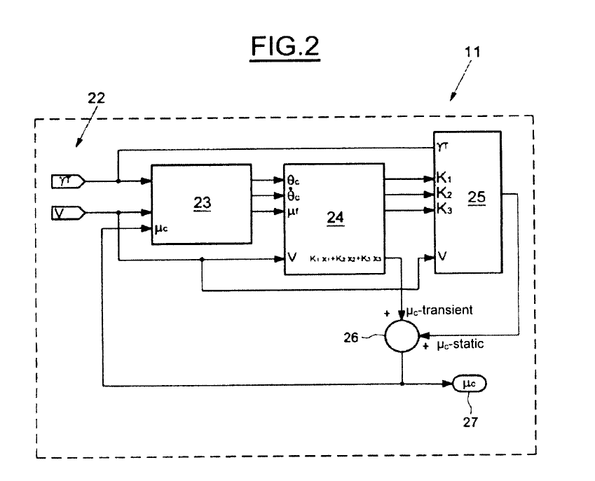

FIG. 2 is a logic diagram of the system of FIG. 1;

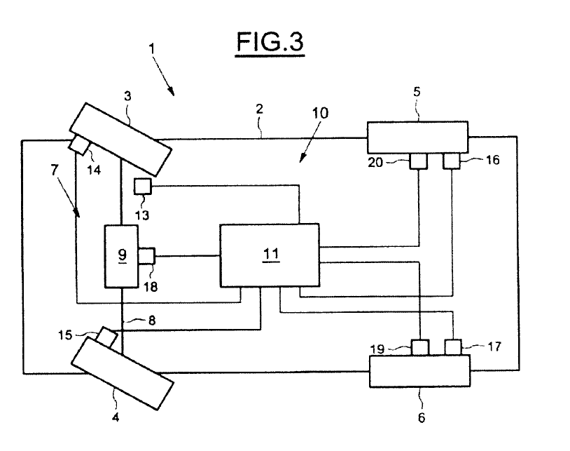

FIG. 3 is a schematic view of a vehicle equipped with a control system according to another aspect of the invention; and

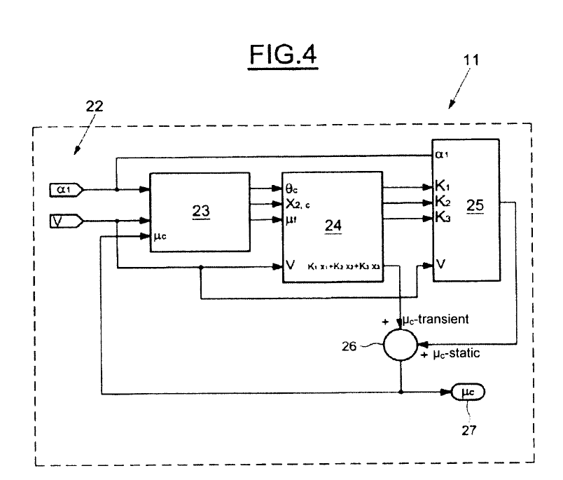

FIG. 4 is a logic diagram of the system of FIG. 3.

As is evident in FIG. 1, vehicle 1 comprises a chassis 2, two front steerable wheels 3 and 4 and two rear wheels 5 and 6, which may or may not be steerable. Vehicle 1 is supplemented by a steering system 7 comprising a rack 8 disposed between front wheels 3 and 4, and a rack actuator 9 capable of orienting front wheels 3 and 4 by means of rack 8 as a function of instructions received mechanically or electrically from a steering wheel, not illustrated, available to the vehicle driver. In the variant with steerable rear wheels, steering-angle actuators 19 and 20 are provided for the said rear wheels.

Anti-rollover control system 10 comprises a control unit 11, a sensor 12 for the lateral acceleration YT of the vehicle, and a sensor 13 for the speed of rotation of the front wheels, making it possible to determine the vehicle speed V. Sensor 12 may be disposed at the center of gravity of vehicle 1.

In addition, anti-rollover system 10 comprises actuators 14 to 17 capable of acting on the stiffness of the suspension disposed between chassis 2 and respectively wheels 3 to 6. The speed sensor may be of optical or else magnetic type, for example of Hall-effect type, cooperating with an encoder integral with a movable part, while the sensor is non-revolving. The acceleration sensor may be of the accelerometer type (bob and spring). Actuators 14 to 17 may comprise hydraulic or electric thrustors capable of modifying the stiffness of the suspension or else active suspension elements with controlled stiffness.

Control unit 11 may be implemented in the form of a microprocessor equipped with a random-access memory, with a read-only memory, with a central unit and with input/output interfaces for receiving information from sensors and sending instructions to actuators 14 to 17.

More precisely, control unit 11 comprises an input block 22 receiving the signals originating from sensors 12 and 13, more particularly the vehicle speed V and the transverse acceleration YT. The vehicle speed may be obtained by forming the average of the speed of the front wheels or of the rear wheels as measured by the sensors of a wheel anti-lock system. In this case, one sensor 13 per wheel is provided, the wheel anti-lock system comprising an output connected to an input of control unit 11 to supply the vehicle speed information. Alternatively, each sensor 13 is connected to an input of control unit 11, in which case control unit 11 forms the average of the speed of the wheels.

Control unit 11 also comprises a vehicle model 23 for estimating information that is not measured but is necessary for control. Model 23 makes it possible to predict the intrinsic behavior of chassis 2, or in other words its roll response as a function of the transverse acceleration γ_{T} of the vehicle. As an example, the model may be based on the simplified equation for the transfer element between the transverse acceleration γ_{T} and the roll angle, denoted θ, of the vehicle body on the one hand, and between the torque, denoted μf, applied by the actuator and the roll angle θ of the vehicle body on the other hand:

$$( {I}_{xx} + {Mh}_{0}^{2} ) \ddot{θ} + ( \frac{{E}_{1}^{2}}{2} {c}_{1} + \frac{{E}_{2}^{2}}{2} {c}_{2} ) \dot{θ} + ( \frac{{E}_{1}^{2}}{2} {k}_{1} + \frac{{E}_{2}^{2}}{2} {k}_{2} - {Mgh}_{0} ) θ = {Mh}_{0} {γ}_{T} + {u}_{f}$$

with Iₓₓ the inertia of the vehicle body around its roll axis, or in other words a longitudinal axis that is located higher than the ground and that may be slightly inclined toward the front, M the total mass of the vehicle, ho the height of the center of gravity relative to the roll axis of the vehicle body, E₁ the path of the front axle, E₂ the path of the rear axle, c₁ the damping coefficient of the front axle, c₂ the damping coefficient of the rear axle, k₁ the stiffness of the front axle, k₂ the stiffness of the rear axle, g the gravitational constant, \dot{θ} the roll rate of the vehicle body and \ddot{θ} the roll acceleration of the vehicle body. The need to measure the torque actually applied by the actuators may be obviated by modeling the actuator dynamics:

$${μ}_{f} = \frac{{μ}_{c}}{{τ}_{a} s + 1}$$

with μ_{f} the applied torque, μ_{c} the torque setpoint, τₐ the actuator dynamics and s the Laplace operator. The equation of state associated with this model is the following:

$$( \begin{matrix}{\dot{θ}}_{c} \\ {\ddot{θ}}_{c} \\ {\dot{u}}_{f}\end{matrix} ) = ( \begin{matrix}0 & 1 & 0 \\ - {ω}_{n}^{2} & - 2 ξ {ω}_{n} & {G}_{u} \\ 0 & 0 & - \frac{1}{{τ}_{a}}\end{matrix} ) \cdot ( \begin{matrix}{θ}_{c} \\ {\dot{θ}}_{c} \\ {u}_{f}\end{matrix} ) + ( \begin{matrix}0 \\ {G}_{γ} \\ 0\end{matrix} ) {γ}_{T} + ( \begin{matrix}0 \\ 0 \\ \frac{1}{{τ}_{a}}\end{matrix} ) {u}_{c}$$

$$y = ( \begin{matrix}1 & 0 & 0 \\ 0 & 1 & 0 \\ 0 & 0 & 1\end{matrix} ) \cdot ( \begin{matrix}{θ}_{c} \\ {\dot{θ}}_{c} \\ {u}_{f}\end{matrix} )$$

with:

$${G}_{γ} = \frac{{Mh}_{0}}{( {I}_{xx} + {Mh}_{0}^{2} )}$$

$${ω}_{n} = \sqrt{\frac{\frac{1}{2} ( {E}_{1}^{2} {k}_{1} + {E}_{2}^{2} {k}_{2} ) - {Mgh}_{0}}{{I}_{xx} + {Mh}_{0}^{2}}}$$

$${G}_{u} = \frac{1}{( {I}_{xx} + {Mh}_{0}^{2} )}$$

$$ξ = \frac{1}{4} ( \frac{{E}_{1}^{2} {c}_{1} + {E}_{2}^{2} {c}_{2}}{{I}_{xx} + {Mh}_{0}^{2}} )$$

and where y is the output under consideration.
Model 23 therefore supplies a calculated roll angle θ_{c}, a calculated roll rate \dot{θ}_{c}
and a roll torque μ_{f} filtered by the actuator dynamics and therefore actually applied.

Control unit 11 additionally comprises a block 24 for calculating transients, receiving at its input the aforesaid outputs of model 23 as well as the speed V of vehicle 1. Block 24 calculates the control signal for acting on the transient response, and it does so by pole assignment. If the three poles of the system described hereinabove are denoted as follows:

a₁(V)+b₁(V)·i a₂(V)+b₂(V)·i a₃(V)+b₃(V)·i

where the real parts of the poles at speed V are denoted aᵢ(V) and the imaginary parts are denoted bᵢ(V). A search then is made for the corrector K=[K₁(V) K₂(V) K₃(V)] that will assign the poles of the looped system at

Tdyn₁₁(V)·a₁(V)+Tdyn₁₂(V)·b₁(V)·i

Tdyn₂₁(V)·a₂(V)+Tdyn₂₂(V)·b₂(V)·i

Tdyn₃₁(V)·a₃(V)+Tdyn₃₂(V)·b₃(V)·i

where Tdyn₁₁, Tdyn₁₂, Tdyn₂₁, Tdyn₂₂, Tdyn₃₁, Tdyn₃₂ are the regulation parameters (variable as a function of the vehicle speed V) of the transient response of the vehicle.

The corrector K(V₀) for each speed V₀ selected may be calculated by the pole assignment method described in the article “Robust Pole Assignment in Linear State Feedback” of J. Kautsky and N. K. Nichols, published in Int. J. Control, 41 (1985), pages 1129 to 1155.

In this way there is obtained the first part of the control signal:

u_{c-transient}=K₁(V)·θ_{c}−K₁(V)·\dot{θ}_{c}−K₃(V)·u_{f}

It can be noted that the dynamic response of the vehicle is not modified when the regulation parameters are equal to 1, that a parameter larger than 1 causes an increase of the promptness of the vehicle response to roll, and that a parameter smaller than 1 causes a reduction in promptness of the vehicle response to roll. As an example, the following regulation may be adopted.

Tdyn₁₁=0.8

Tdyn₁₂=0

Tdyn_{21=0.8}

Tdyn₂₂=0

Tdyn₃₁=0.8

Tdyn₃₂=0

This regulation makes it possible to slow the dynamic response of the vehicle while suppressing roll oscillations. Such regulation makes it possible to improve the comfort of the passenger, who will feel a less abrupt roll effect when entering a turn.

At its output, therefore, block 24 supplies the coefficients K₁, K₂ and K₃ and the first part of the control signal, denoted μ_{c-transient}.

Control unit 11 additionally comprises a block 25 for calculating the static control signal, denoted μ_{c-static}, receiving at its input the coefficients K₁, K₂ and K₃ originating from block 24, the vehicle speed V and the transverse acceleration γ_{T}. The control signal μ_{c-static} makes it possible to modify the stabilized value of the roll angle of the body attained following a turn of the steering wheel by a given amplitude. The result may be expressed by comparison with the static gain that would be obtained on the same vehicle without an active anti-rollover device:

$${[ \frac{{θ}_{STABILIZED}}{{γ}_{T}} ]}_{ACTIVE \text{-} ANTI \text{-} ROLLOVER} = Tgs \cdot {[ \frac{{θ}_{STABILIZED}}{{γ}_{T}} ]}_{WITHOUT \text{-} ACTIVE \text{-} ANTI \text{-} ROLLOVER}$$

where Tgs is the regulation parameter that may vary as a function of the speed V if necessary.

The second part of the control signal is calculated as follows as a function of the parameter Tgs:

$${μ}_{c \text{-} static} = [ ( Tgs - 1 ) \cdot ( 1 + {K}_{3} ( V ) ) \cdot \frac{{G}_{γ}}{{G}_{u}} + Tgs \cdot \frac{{K}_{1} ( V ) \cdot {G}_{γ}}{{ω}_{n}^{2}} ] \cdot {γ}_{T}$$

with, as a reminder:

$${G}_{γ} = \frac{{Mh}_{0}}{( {I}_{xx} + {Mh}_{0}^{2} )}$$

$${ω}_{n} = \sqrt{\frac{\frac{1}{2} ( {E}_{1}^{2} {k}_{1} + {E}_{2}^{2} {k}_{2} ) - M \cdot g \cdot {h}_{0}}{{I}_{xx} + {Mh}_{0}^{2}}}$$

$${G}_{u} = \frac{1}{( {I}_{xx} + {Mh}_{0}^{2} )}$$

$$ξ = \frac{1}{4} ( \frac{{E}_{1}^{2} {c}_{1} + {E}_{2}^{2} {c}_{2}}{{I}_{xx} + {Mh}_{0}^{2}} )$$

It can be noted that the static response of the vehicle is not modified when the parameter Tgs is equal to 1, that the static response of the vehicle is enhanced when the parameter Tgs is larger than 1, and that the static response of the vehicle is diminished when the parameter Tgs is smaller than 1. As an example, Tgs may be taken as equal to 0.8, thus making it possible to reduce the roll attained by the vehicle body during a stabilized turn and therefore substantially increasing the comfort of the passengers.

Control unit 11 is supplemented by an adder 26 and an output 27. Adder 26 receives at one input the output control signal μ_{c-transient} of block 24 and at another positive input the output control signal μ_{c-static} of block 25. The output of adder 26 is connected on the one hand to general output 27 of control unit 11 and on the other hand to the input of model 23, to supply the said model 23 with the roll-correction setpoint that has just been calculated.

In the embodiment illustrated in FIG. 3, transverse acceleration sensor 12 is replaced by a sensor 18 for the steering-angle position of front wheels 3 and 4, mounted on actuator 9, for example. The steering angle of front wheels 3 and 4 is denoted α₁ and is used by vehicle model 23 as illustrated in FIG. 4, to calculate the calculated roll angle θ_{c}, a roll state X_{2,c} of the vehicle and the roll torque, denoted μ_{f}, filtered by the actuator dynamics which is therefore actually applied.

Control unit 11 as illustrated in FIG. 4 is similar to that illustrated in FIG. 2, with the difference that model 23 may be based, for example, on the following equation, where α₁ is the steering angle of the front wheels:

$$( {I}_{xx} + {Mh}_{0}^{2} ) \ddot{θ} + ( \frac{{E}_{1}^{2}}{2} {c}_{1} + \frac{{E}_{2}^{2}}{2} {c}_{2} ) \dot{θ} + ( \frac{{E}_{1}^{2}}{2} {k}_{1} + \frac{{E}_{2}^{2}}{2} {k}_{2} - {Mgh}_{0} ) θ = {MVh}_{0} \frac{12}{L} {\dot{α}}_{1} + {MV}^{2} \frac{{h}_{0}}{L} {α}_{1} + {μ}_{f}$$

The torque μ_{f} actually applied by the actuator is not measured as was done in the foregoing but is obtained by modeling the actuator dynamics in the same way as in the foregoing.

$${μ}_{f} = \frac{{μ}_{c}}{{τ}_{a} s + 1}$$

The equation of state associated with this model is the following:

$$( \begin{matrix}{\dot{θ}}_{c} \\ {\dot{X}}_{2 , c} \\ {\dot{u}}_{f}\end{matrix} ) = ( \begin{matrix}- 2 ξ {ω}_{n} & 1 & 0 \\ - {ω}_{n}^{2} & 0 & {G}_{u} \\ 0 & 0 & - \frac{1}{{τ}_{a}}\end{matrix} ) \cdot ( \begin{matrix}{θ}_{c} \\ {X}_{2 , c} \\ {u}_{f}\end{matrix} ) + ( \begin{matrix}{G}_{α} \cdot τ \\ {G}_{α} \\ 0\end{matrix} ) {α}_{1} + ( \begin{matrix}0 \\ 0 \\ \frac{1}{{τ}_{a}}\end{matrix} ) {u}_{c}$$

$$y = ( \begin{matrix}1 & 0 & 0 \\ 0 & 1 & 0 \\ 0 & 0 & 1\end{matrix} ) \cdot ( \begin{matrix}{θ}_{c} \\ {X}_{2 , c} \\ {u}_{f}\end{matrix} )$$

with:

$${G}_{α} = \frac{{MV}^{2} h 0}{L \cdot ( {I}_{xx} + {Mh}_{0}^{2} )}$$

$${ω}_{n} = \sqrt{\frac{\frac{1}{2} ( {E}_{1}^{2} {k}_{1} + {E}_{2}^{2} {k}_{2} ) - {Mgh}_{0}}{{I}_{xx} + {Mh}_{0}^{2}}}$$

$$τ = \frac{{L}_{2}}{V}$$

$$ξ = \frac{1}{4} ( \frac{{E}_{1}^{2} {c}_{1} + {E}_{2}^{2} {c}_{2}}{{I}_{xx} + {Mh}_{0}^{2}} )$$

$${G}_{u} = \frac{1}{( {I}_{xx} + {Mh}_{0}^{2} )}$$

and where y is the output under consideration and X_{2,c} is the second state of the vehicle in roll defined by X_{2,c}=2ξωₙθ_{c}+θ_{c}−G_{α}Σ.α₁.

Block 24 for calculating transients may be similar to that illustrated in FIG. 2.

Block 25 for calculating the static control signal makes it possible to modify the stabilized value of the roll angle of the body attained following a turn of the steering wheel by a given amplitude. The result is expressed by comparison with the static gain that would be obtained on the same vehicle without an active anti-rollover device:

$${[ \frac{{θ}_{STABILIZED}}{{α}_{1}} ]}_{ACTIVE \text{-} ANTI \text{-} ROLLOVER} = Tgs \cdot {[ \frac{{θ}_{STABILIZED}}{{α}_{1}} ]}_{WITHOUT \text{-} ACTIVE \text{-} ANTI \text{-} ROLLOVER}$$

where Tgs is the regulation parameter that may vary as a function of the speed V if necessary.

The second part of the control signal is calculated as follows as a function of the parameter Tgs:

$${μ}_{c \text{-} static} = [ \begin{matrix}( Tgs - 1 ) ( 1 + {K}_{3} ( V ) ) \cdot \frac{{G}_{α}}{{G}_{u}} + \\ Tgs ( \frac{{K}_{1} ( V ) \cdot {G}_{α}}{{ω}_{n}^{2}} + \frac{2 {K}_{2} ( V ) ξ {G}_{α}}{{ω}_{n}} ) - {K}_{2} ( V ) {G}_{α} τ\end{matrix} ] {α}_{1}$$

with, as a reminder:

$${G}_{a} = \frac{{MV}^{2} h 0}{L \cdot ( {I}_{xx} + {Mh}_{0}^{2} )}$$

$${ω}_{n} = \sqrt{\frac{\frac{1}{2} ( {E}_{1}^{2} {k}_{1} + {E}_{2}^{2} {k}_{2} ) - {Mgh}_{0}}{{I}_{xx} + {Mh}_{0}^{2}}}$$

$$τ = \frac{{L}_{2}}{V}$$

$$ξ = \frac{1}{4} ( \frac{{E}_{1}^{2} {c}_{1} + {E}_{2}^{2} {c}_{2}}{{I}_{xx} + {Mh}_{0}^{2}} )$$

$${G}_{u} = \frac{1}{( {I}_{xx} + {Mh}_{0}^{2} )}$$

Control unit 11 is supplemented as in the preceding embodiment, by a summing unit that receiving at its input the output μ₂₋ₜᵣₐₙₛᵢₑₙₜ of block 24 on the one hand and the output μ_{2-static} originating from block 25 on the other hand.

The invention offers a control signal rule that adjusts the active anti-rollover system and that, by virtue of an open-loop strategy, makes it possible to regulate the dynamic and static roll responses of the vehicle as a function of the lateral acceleration or of the steering angle of the front wheels. As an example, the regulation may be a function of the vehicle speed V. The vehicle is designed in such a way as to adopt the most stable behavior possible regardless of the maneuvers of the driver and the road condition, and it offers greatly enhanced safety, a good feeling of safety and optimized comfort and driving pleasure.

The invention is applicable in particular to vehicles equipped with active roll bars. It is possible to switch to sensors of the roll dynamics of the vehicle, thus making it possible to limit the cost of the system and to allow for the dynamics of the anti-rollover actuator. Adjustment of the regulation is rapid and intuitive, because the regulation parameters are related to the nominal performances of the vehicle in the absence of an anti-rollover device. In effect, regulation parameters equal to 1 do not modify the vehicle behavior, while regulation parameters larger than 1 make the vehicle behavior more responsive and regulation parameters smaller than 1 make the vehicle behavior less direct. The use of the anti-rollover system ensures good vehicle behavior regardless of the grip offered by the wheel on which the vehicle is traveling.

1- A method for control of an anti-rollover system for a vehicle having at least three wheels wherein, as a function of the steering angle of the front wheels or of the lateral acceleration of the vehicle, of displacement data of the vehicle and of a prior steering-angle setpoint of the anti-rollover system, a current setpoint is formulated for roll correction and the said current roll-correction setpoint is sent to an anti-rollover actuator or to an adjustable suspension acting on the stiffness of a vehicle suspension.

2- A method according to claim 1, wherein the said displacement data of the vehicle comprise the longitudinal speed V of the vehicle.

3- A method according to claim 1 or 2, wherein the said displacement data of the vehicle comprise a measurement of the steering angle of the rear wheels.

4- A method according to any one of the preceding claims, wherein the dynamic response of the vehicle and the static response of the vehicle are regulated separately.

5- A method according to any one of the preceding claims, wherein a current roll-correction setpoint is formulated from a model of the vehicle and displacement data of the vehicle.

6- A method according to any one of the preceding claims, wherein the current roll-correction setpoint is formulated in an open loop.

7- A method according to any one of the preceding claims, wherein the roll-correction setpoint is formulated as a function of the dynamics of the said anti-rollover actuator or adjustable suspension.

8- An anti-rollover system for a vehicle (1) having at least three wheels, comprising a means (11) for formulating a current roll-correction setpoint as a function of the steering angle of the front wheels or of the vehicle acceleration, of displacement data of the vehicle and of a prior roll-correction setpoint, and an anti-rollover actuator (14 to 17) or an adjustable suspension capable of acting on the stiffness of a vehicle suspension upon reception of the said current roll-correction setpoint.

9- A system according to claim 8, wherein the said means for formulating a setpoint comprises a modeling module (23) capable of furnishing an estimate of at least one variable.

10- A system according to claim 9, wherein the said modeling module (23) comprises an input for the steering angle of the front wheels or for the lateral acceleration of the vehicle, an input for the speed V of displacement of the vehicle and an input for the prior setpoint of the steering angle of the rear wheels.

11- A system according to claim 9 or 10, wherein the said modeling module (23) comprises an output for roll angle, an output for roll rate and an output for filtered torque.

12- A system according to any one of claims 8 to 11, wherein the said means for formulating a setpoint comprises a module (24) for regulating the transient part and a module (25) for regulating the static part.

13- A system according to claim 12, wherein the said module (24) for regulating the transient part comprises outputs connected to the inputs of the module for regulating the static part, the module (25) for regulating the static part additionally comprising an input for the steering angle of the front wheels or for the lateral acceleration of the vehicle and an input for the speed V of displacement of the vehicle.

14- A vehicle (1) provided with a chassis (2) and at least three wheels attached elastically to the chassis (2), comprising an anti-rollover system comprising a means (11) for formulating a current roll-correction setpoint as a function of the steering angle of the front wheels or of the lateral acceleration of the vehicle, of displacement data of the vehicle and of a prior roll-correction setpoint, and an anti-rollover actuator (14 to 17) or an adjustable suspension capable of acting on the stiffness of a vehicle suspension upon reception of the said current roll-correction setpoint.
